(19) United States
(12) Patent Application Publication
(10) Pub. No.: US 2008/0062939 A1
(43) Pub. Date: Mar. 13, 2008

(54) WIRELESS COMMUNICATIONS BETWEEN A PERIPHERAL AND A MOBILE UNIT IN A WIRELESS NETWORK ENVIRONMENT

(76) Inventors: Peter Van Horn, San Jose, CA (US); David Friedman, Atherton, CA (US)

Correspondence Address: EDOUARD GARCIA, 501 PALMER LN, MENLO PARK, CA, 04025-1941, US

(21) Appl. No.: 11/754,943

(22) Filed: May 29, 2007

Related U.S. Application Data
(60) Provisional application No. 60/842,799, filed on Sep. 7, 2006.

(51) Int. Cl. H04Q 7/24

(52) U.S. Cl. 370/338

(57) ABSTRACT

Systems and methods of wireless communications between a peripheral and a mobile unit in a wireless network environment are described. In one aspect, a trigger frame is wirelessly transmitted in accordance with a wireless local area network (LAN) communications protocol in response to a determination to acquire data wirelessly from a target peripheral. The trigger frame reserves a wireless channel for a duration sufficient to meet a time needed by the target peripheral to transmit local data. The target peripheral awaits receipt of a trigger frame from a target mobile unit before wirelessly transmitting local data. In response to receipt of the trigger frame, the target peripheral transmits the local data to the target mobile unit over the wireless channel during the reserved duration in accordance with a wireless local area network (LAN) communications protocol.

### CROSS-REFERENCE TO RELATED APPLICATIONS

Under 35 U.S.C. § 119(e), this application claims the benefit of U.S. Provisional Application No. 60/842,799, filed Sep. 7, 2006, the entirety of which is incorporated herein by reference.

### BACKGROUND

There are currently many mobile units enabled with wireless functionality for communication with other wireless mobile units or a broader distribution network. In order for these devices to support wireless accessories, they must either have an additional radio, or cease communication with other devices or distribution networks.

Especially in the PC space, peripherals such as wireless mice, headsets, and other human interface devices typically do not communicate with the existing 802.11 chips in the personal computer (PC). Instead, they typically communicate through a different radio, often by using a separate USB dongle attachment or perhaps a different embedded radio, such as Bluetooth. In either case, the PC requires at least two radios to support simultaneous communication with a wireless local area network (LAN) and a wireless peripheral. Handsets and other mobile devices also require two radios to manage the primary role of communicating with the network while also working with a wireless peripheral. Game consoles that offer Wi-Fi connectivity often use proprietary radios or Bluetooth radios to connect to the wireless game controllers. In these examples, the primary radio is not used to simultaneously support external communication with other networked devices and wireless peripherals.

The result of requiring a separate radio to manage each function is higher system power and additional cost and, when dongles are required, a poor user experience.

### SUMMARY

In one aspect, the invention features a method in accordance with which a trigger frame is wirelessly transmitted in accordance with a wireless local area network (LAN) communications protocol in response to a determination to acquire data wirelessly from a target peripheral. The trigger frame reserves a wireless channel for a duration sufficient to meet a time needed by the target peripheral to transmit local data, and the trigger frame prompts the target peripheral to transmit the local data over the wireless channel during the reserved duration in accordance with a wireless local area network (LAN) communications protocol. Local data transmitted by the target peripheral is received over the wireless channel. The received local data is processed.

In another aspect, the invention features a method that includes awaiting receipt of a trigger frame from a target mobile unit before wirelessly transmitting local data. The trigger frame reserves a wireless channel for a duration sufficient to meet a time needed to transmit the local data to the target mobile unit in accordance with a wireless local area network (LAN) communications protocol. In response to receipt of the trigger frame, the local data is transmitted to the target mobile unit over the wireless channel during the reserved duration in accordance with a wireless local area network (LAN) communications protocol.

In another aspect, the invention features a system that includes a mobile unit. The mobile unit includes a processing system and an RF radio transceiver. In response to a determination to acquire data wirelessly from a target peripheral, the mobile unit wirelessly transmits a trigger frame via the RF radio transceiver in accordance with a wireless local area network (LAN) communications protocol. The trigger frame reserves a wireless channel for a duration sufficient to meet a time needed by the target peripheral to transmit local data to the mobile unit over the wireless channel during the reserved duration in accordance with a wireless LAN communications protocol.

In another aspect, the invention features a system that includes a peripheral. The peripheral includes a processing system and an RF radio transceiver. The peripheral awaits receipt of a trigger frame from a target mobile unit before wirelessly transmitting local data. The trigger frame reserves a wireless channel for a duration sufficient to meet a time needed to transmit the local data to the target mobile unit in accordance with a wireless local area network (LAN) communications protocol. In response to receipt of the trigger frame, the peripheral transmits the local data to the target mobile unit over the wireless channel during the reserved duration in accordance with a wireless LAN communications protocol.

Other features and advantages of the invention will become apparent from the following description, including the drawings and the claims.

### DESCRIPTION OF DRAWINGS

FIG. 1 is a block diagram of an embodiment of a wireless local area network that includes an access point, a mobile unit, and a peripheral.

FIG. 2 is a flow diagram of an embodiment of a method of transitioning a mobile unit and a peripheral between different phases of a communications protocol.

FIG. 3 is a flow diagram of an embodiment of a method of communicating with a peripheral and other network nodes.

FIG. 4 is a flow diagram of an embodiment of a method of transmitting data from a peripheral to a target mobile unit.

FIG. 5 is a timing diagram of data transmissions between a mobile unit and a peripheral in accordance with the methods shown in FIGS. 3 and 4.

FIG. 6 is a timing diagram of data transmissions between a mobile unit and a peripheral in accordance with the methods shown in FIGS. 3 and 4.

FIG. 7 is a flow diagram of an embodiment of a method of transmitting data from a peripheral to a target mobile unit.

FIG. 8 is a timing diagram of data transmissions between a mobile unit and a peripheral in accordance with the method shown in FIG. 7.

FIG. 9 is a flow diagram of an embodiment of a method of operating a peripheral.

FIG. 10 is a diagrammatic view of an embodiment of a wireless local area network.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. INTRODUCTION

The embodiments that are described herein provide systems and methods of wireless communications between a peripheral and a mobile unit in a wireless network environment. In accordance with these embodiments, the mobile unit initiates all data exchanges between the mobile unit and the peripheral using a trigger frame. The peripheral delays any data transmissions to the mobile unit until the peripheral receives the trigger frame from the mobile unit. In some embodiments, this feature is leveraged to: enable the mobile unit to clear a wireless channel for communications between the mobile unit and the peripheral; enable the mobile unit to optimize the multiplexing of a wireless communications resource between peripheral communications and other network communications; and enable the peripheral to reduce power consumption during periods when data is not being exchanged with the mobile unit.

### II. EXEMPLARY OPERATIONAL ENVIRONMENTS

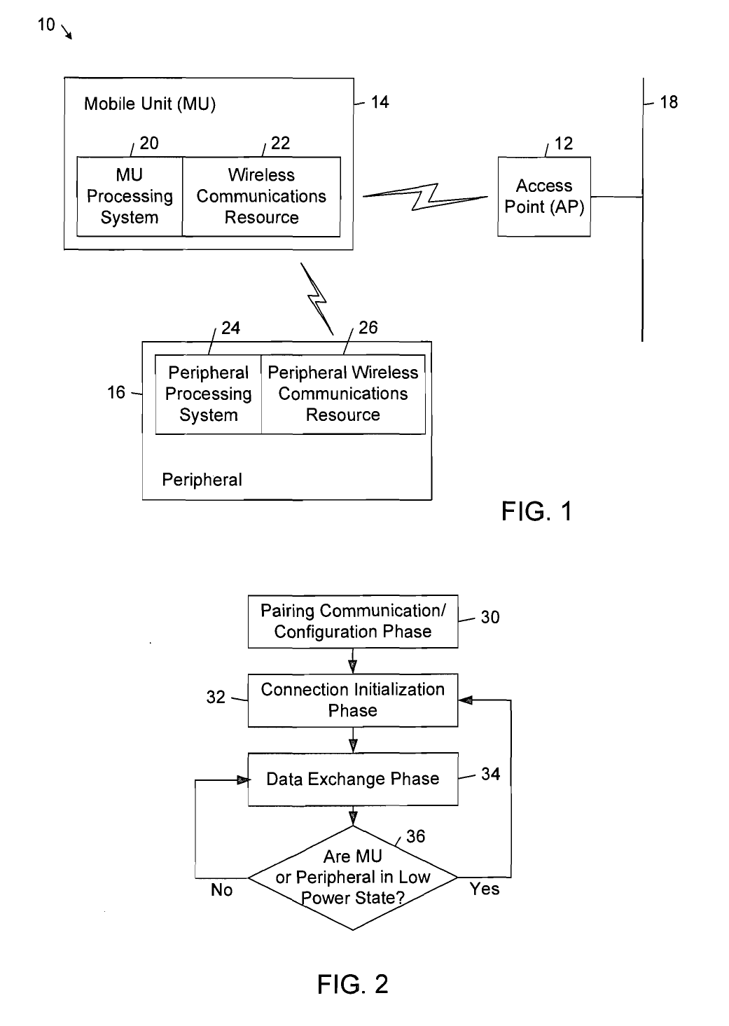

FIG. 1 shows an embodiment of a wireless local area network 10 that includes an access point 12, a mobile unit 14, and a peripheral 16.

The access point 12 acts as a communications hub for communications between the mobile unit 14 and a wired network 18, which typically is a local area network.

The mobile unit 14 may be implemented by any type of electronic device that is capable of communicating wirelessly in accordance with a wireless local area network (LAN) communications protocol (e.g., the IEEE 802.11 protocol), including desktop computers, laptop and notebook computers, personal digital assistants, and video game consoles. In the illustrated embodiment, the mobile unit 14 includes a processing system 20 and a single wireless communications resource 22. The wireless communications resource 22 typically has a single RF transceiver and a wireless chipset that includes at least one communications processor.

The peripheral 16 may be implemented by any device that is capable of providing input to the mobile unit 14 or presenting output from the mobile unit 14. Examples of input peripherals are computer keyboards, computer mice, touch screens, joysticks, and video game controllers. Examples of output peripherals are printers, audio speakers, and monitors. In the illustrated embodiment, the peripheral 16 includes a processing system 24 and a wireless communications resource 26. The wireless communications resource 26 typically has a single RF transceiver and a wireless chipset that includes at least one communications processor. The wireless communications resource 26 of the peripheral 16 typically has much less transmission and computing power capabilities than the wireless communications resource 22 of the mobile unit 14.

Some embodiments of the peripheral 16 may be associated with a docking station that is used to store the peripheral 16 when it is not in normal use. The docking station may have various hardwired connections that allow it to recharge the batteries of the peripheral 16 and/or establish communication with the mobile unit 14 through a hardwired link such as USB.

As explained in detail below, the mobile unit 14 uses the single wireless communications resource 22 to communicate wirelessly with the access point 12 and the peripheral 16. These communications typically are performed in accordance with a wireless LAN communications protocol, such as IEEE 802.11, which supports peer-to-peer communications among the network nodes. In this process, the mobile unit 14 communicates with the access point 12 in accordance with the IEEE 802.11 wireless local area network (LAN) protocol, and the mobile unit 14 communicates with the peripheral 16 in accordance with the same version or a modified version of the IEEE 802.11 protocol.

In some exemplary application environments, a wireless mouse or a wireless headset connects to a personal computer (PC) implementation of the mobile unit (MU) 14 that has an embedded RF transceiver chip (e.g., a Wi-Fi chip). Using software or hardware modifications, the embedded RF transceiver chip is configured so that it can operate in infrastructure mode, communicating through the wireless medium to the access point 12 or other wireless device, while at the same time transmitting/receiving signals from the wireless mouse or the wireless headset. In some embodiments, a software program executed by the processing system 20 of the mobile unit 14 allows the embedded RF transceiver chip to operate simultaneously in infrastructure mode and ad hoc mode, in ad hoc mode with multiple devices, or by using a different channel specifically for the wireless mouse or the wireless headset. In other application environments, a wireless MP3 player or a dual-mode wireless mobile telephone is configured to communicate directly with the access point 12.

### III. OVERVIEW OF PERIPHERAL-MOBILE UNIT COMMUNICATIONS

A. Introduction

In some embodiments, a single embedded radio transceiver in an existing mobile unit 14 is configured via software and/or hardware modifications to manage the process of communicating with other stations, nodes, or distribution networks, while at the same time communicating with the wireless peripheral 16. The software and hardware of an existing wireless peripheral may be modified to enable this functionality. Software modifications may be done via download, CD-ROM or other removable media, or come included with the MU upon delivery. In PC implementations of the MU 14, the driver to an existing 802.11 chipset is configured in such a way as to enable the PC to communicate with an access point 12 and connect to the infrastructure while also communicating directly with the wireless peripheral 16.

In some embodiments, a wireless peripheral is configured through hardware/software to appear to be an access point. The mobile unit 14 is configured through hardware/software to always look for the wireless peripheral, and to communicate with the peripheral 16 as required. In the case of a wireless mouse, for example, movement of the mouse would cause the mouse to “wake up,” upon which the mouse would transmit a signal to the mobile unit 14. The mobile unit 14 has been configured in such a way that it is always listening for the signal from the mouse. If the mobile unit 14 is already communicating with the access point 12, it will send a packet to the access point 12 that it is temporarily going to sleep, and it will then “switch access points” in order to receive packets from the mouse.

In other embodiments, the software driver for the wireless communications resource 22 of the mobile unit 14 is designed to simultaneously communicate with the access point 12 and one or more peripheral devices (keyboard, mouse, etc) in a way that allows it to share/multiplex its single wireless communications resource 22 among these multiple transmitters. These peripherals act as data providers to the mobile unit 14, but they transmit their data only when polled by the mobile unit 14 which allows the mobile unit 14 to multiplex its single radio between the access point 12 and these multiple devices. A structured addressing scheme allows the mobile unit 14 and peripherals to target frames to each other without the presence of the access point 12. When polled the peripheral immediately transmits its data packet(s) to update the mobile unit 14 with the latest information and then waits for the next poll (or trigger) frame from the mobile unit 14. Meanwhile the mobile unit 14 resumes communication with the access point 12 until another opportunistic moment arrives after a scheduled fixed interval at which time it will again poll the peripheral 16 for more data. This process will continue around a fixed interval. In some implementations, the bandwidth consumed by each peripheral communication may be approximately 3% of the overall available bandwidth.

In some embodiments, the mobile unit 14 is loaded (e.g., via CD-ROM or other data transfer method) with software that configures an embedded IEEE 802.11 chip set via drivers to enable simultaneous communication with the access point 12 and the wireless peripheral 16. The wireless peripheral 16 might be configured in such a way that it only communicates with a mobile unit 14 that “knows” the device. This relationship might be established through a specific code or “handshake” during device configuration. In some embodiments, the keys of the mouse (or keyboard, etc.) may be depressed both at once (or some other unusually complex activity) to cause the peripheral to enter into a configuration mode allowing it to communicate with the mobile unit 14 that has received the configuration software. This feature allows the mobile unit 14 to interact with the peripheral 16 in a secure manner during a coordinated period of time. In one embodiment, the peripheral 16 communicates with the mobile unit 14 in ad hoc network structure mode while the mobile unit 14 communicates with the access point 12 in infrastructure network structure mode. In another embodiment, the peripheral 16 communicates with the mobile unit 14 using a particular wireless channel, while the mobile unit 14 uses other wireless channels for communicating with the access point 16 as long as the peripheral 16 also is linked to the mobile unit 14.

B. Phases of an Exemplary Communications Protocol

In some embodiments, the communication between the peripheral 16 and the mobile unit (MU) 14 can be separated into three phases. Phase 1 is the Pairing Communication phase which occurs one time at the beginning of a MU-peripheral relationship and may or may not occur over wireless media. In order for a peripheral to communicate with a different MU a new Phase 1 exchange must take place at which point any previous pairings are discarded or abandoned. It is intended, under normal operation, that a Phase 1 exchange would be required only rarely over the lifetime of the peripheral. Phase 2 is the Connection Initialization phase which occurs each time the peripheral and MU come out of a low power State and enter into an operational State. This phase is used to establish any session information and to also allow for each device to recognize the wake State of the other paired device. Phase 2 could be considered an optional phase as deemed appropriate by the governing application logic. Phase 3 is the data exchange phase which can occur any number of times following a successful Phase 2 exchange and before the next transition by either device into a low power or ‘off’ State. Together these 3 phases represent all of the communication that occurs between a peripheral and its paired MU.

FIG. 2 shows an embodiment of a method of transitioning a mobile unit and a peripheral between the different phases of the communications protocol.

Communications between the mobile unit 14 and the peripheral 16 begin with the pairing communication/configuration phase (FIG. 2, block 30). This phase occurs one time when the peripheral is first used with the MU and the user desires to establish a pairing. It is analogous to plugging a peripheral into a laptop computer as from that point forward the 2 devices are ‘paired’. Like a hardwired pairing this wireless pairing can survive multiple asynchronous power cycles on both the peripheral and the MU. This is accomplished by storing the results of the pairing communication in non-volatile memory (NVM) and re-loading it whenever the subject device (MU or peripheral) is provided power. The pairing communication may also occur using the IEEE 802.11 communications protocol provided that both MU and peripheral could be put into a special mode allowing them to receive and transmit pairing information. Alternatively, the pairing communication may occur over a hardwired link between the MU and peripheral such as USB. Such a link might exist as a docking station service for the peripheral. Some of the data that is expected to be exchanged during the pairing communication might include the following; the MAC address of the MU, the MAC address of the peripheral, the preferred radio channel on which to communicate. The desired rate/frequency of data exchange during operation, the preferred transmit power to be used by the peripheral when transmitting to the MU, the security keys and method of data encryption if any to use when communicating with the wireless connection.

After the mobile unit 14 and the peripheral 16 have been paired, the mobile unit 14 is referred to herein as a “target mobile unit” of the peripheral 16 and the peripheral 16 is referred to herein as a “target peripheral” of the mobile unit 14.

After the pairing communication/configuration phase (FIG. 2, block 30), the mobile unit 14 and the peripheral 16 enter a connection initialization phase of communication (FIG. 2, block 32). This phase occurs each time the MU 14 and peripheral 16 first attempt communication after being in a low power or ‘off’ state (FIG. 2, block 36). In the case of a mouse or other battery-powered peripheral, this typically occurs when the mouse is first moved after having been idle for several minutes. After a moment of inactivity the peripheral 16 transitions into a low power state (FIG. 2, block 34). It then requires user action to be brought out of that state. While in this low power state no communication takes place between the peripheral 16 and the MU 14. It is therefore necessary for the devices to re-establish communication and learn if the paired device is able to receive transmissions. In some embodiments, the communication exchange is initiated by the peripheral 16. In other embodiments, the communication exchange is initiated by the MU.

After the pairing connection initialization phase (FIG. 2, block 32), the mobile unit 14 and the peripheral 16 enter a data exchange phase of communication (FIG. 2, block 34). This phase occurs whenever one of the devices wants to communicate data to its paired device and the connection initialization phase has been successfully completed since after the last low power transition (FIG. 2, block 36).

C. Embodiments of Wireless Communications During the Data Exchange Phase of the Communications Protocol

Typically, the peripheral 16 is a low power device relative to the MU 14. Therefore it is desirable for the peripheral 16 to transmit its data at the lowest possible power. Unfortunately, successful and efficient communications in accordance with a wireless LAN communications protocol, such as IEEE 802.11, require that every transmitting device be able to hear and understand the transmissions of every other transmitting device whenever transmission ranges overlap. If the peripheral 16 transmits at low power then it is very possible for other devices to not hear the transmission and incorrectly assume that the wireless medium is available. Making that assumption the other device may also transmit causing the low power peripheral transmission to become corrupted or lost by the MU 14 for which it was targeted.

To solve this problem, the MU 14 initiates each data exchange by transmitting a trigger frame that contains a duration value sufficient to reserve the wireless medium long enough for the peripheral 16 to complete its low power transmission. In this process, the mobile unit 14 attempts to reserve the air space for a sufficiently long duration to allow the peripheral 16 to transmit its data. In some embodiments, the duration value is preset by the manufacturer of the RF transceiver in the MU 14. In other embodiments, the MU 14 determines the duration value dynamically using a lookup table indexed to the device type of the peripheral 16 (e.g., computer mouse, keyboard, or game controller). In other embodiments, the MU 14 determines the duration value dynamically based on information received from the peripheral 16. For example, the peripheral 16 may include with each local data transmission information specifying the expected amount of local data that will be sent with the next transmission. The MU 14 may use this information to calculate the length of time needed by the peripheral 16 for the next transmission from the expected amount of data and the data rate (see § IV.B below). The peripheral 16 would therefore wait to hear the trigger frame from its MU before it transmitted its data frame. Likewise, if the peripheral 16 does not hear the trigger frame then it does not transmit but instead may continue to update its local data as deemed appropriate by the governing logic of the peripheral.

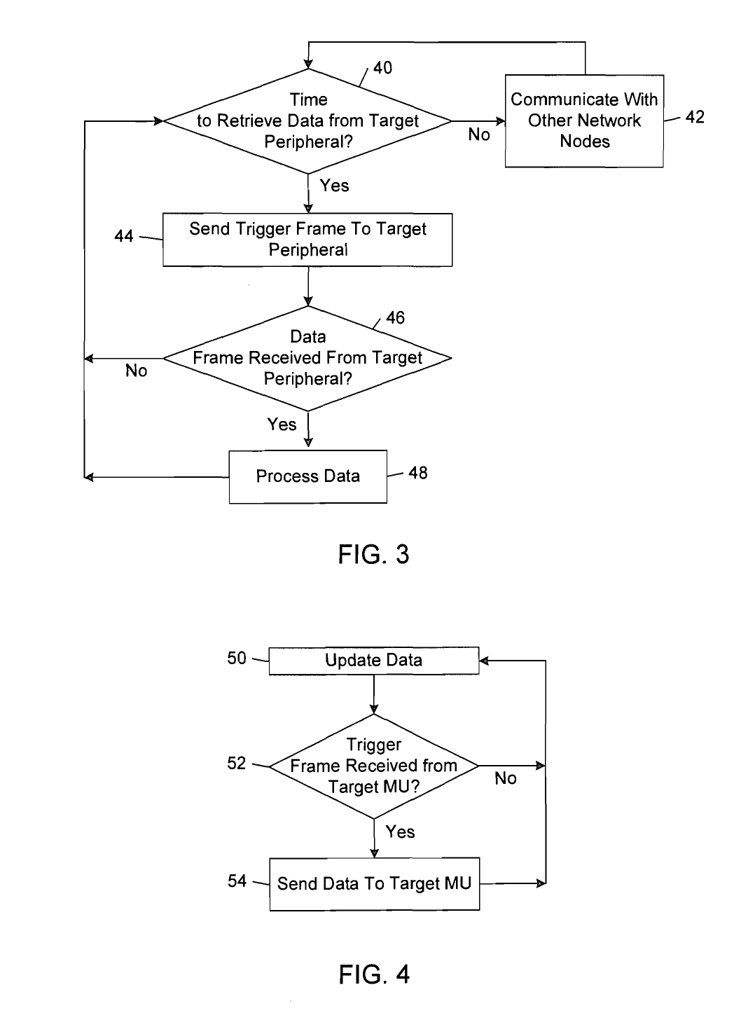

FIG. 3 shows an embodiment of a method by which the mobile unit 14 communicates with the peripheral 16 and other network nodes.

In accordance with this embodiment, the mobile unit 14 determines whether it is time to retrieve data from the target peripheral 16 (FIG. 3, block 40). If it is not time to retrieve data from the target peripheral 16, the mobile unit 14 communicates with other nodes (or stations) on the network (e.g., the access point 12) (FIG. 3, block 42). If it is time to retrieve data from the target peripheral 16, the mobile unit 14 sends a trigger frame to the target peripheral 16 (FIG. 3, block 44). In response to receipt of the trigger frame, the target peripheral 16 transmits at least one data frame over the reserve wireless channel during the reserved duration in accordance with a wireless LAN communications protocol (e.g., IEEE 802.11). If the data frame is received successfully by the mobile unit 14 (FIG. 3, block 46), the MU 14 processes the data (FIG. 3, block 48). Whether or not the data frame is received successfully by the mobile unit 14 (FIG. 3, block 46), the mobile unit 14 repeats the process at the scheduled interval (FIG. 3, blocks 40-48).

In the embodiment shown in FIG. 3, the mobile unit repeats the transmission of the trigger frames at regular intervals of time without regard to receipt of any data frames (e.g., IEEE 802.11 data frames) containing the local data from the peripheral 16. Thus, the mobile unit's failure to receive a data frame from the peripheral is dealt with in a way that minimizes the impact on future communication. In this way, the ongoing communication between the mobile unit 14 and the target peripheral 16 is able to sustain multiple data exchange failures.

The trigger frame may correspond to any type of frame that contains a duration value that informs the other nodes in the network 10 to suspend their respective transmissions for the specified duration and at least one address, which typically is the address or ID assigned to the peripheral. In some embodiments, the trigger frame is a “clear to send” (CTS) frame, which carries the information specifying the duration of the peripheral data transmission and the network address or ID of the peripheral 16. In response to receipt of the CTS frame, all other nodes in the network 10 update their respective network allocation vectors (NAVs) with the specified duration information. All these other nodes will avoid transmitting on the wireless channel during the specified duration. In some embodiments, the trigger frame includes an identifier that identifies the target mobile unit 14, an identifier that identifies the target peripheral 16, and a duration that specifies a length of time that is reserved for transmitting data from the target peripheral 16 to the mobile unit 14. For example, the trigger frame may correspond to an IEEE 802.11 data frame that includes the duration information, a source address value corresponding to the network address or ID of the MU 14, and a destination address value corresponding to the network address or ID of the peripheral 16.

FIG. 4 shows an embodiment of a method by which the peripheral 16 transmits data to the target mobile unit 14. In accordance with this embodiment, the peripheral 16 updates its local data (FIG. 4, block 50). If a trigger frame is received from the target mobile unit 14 (FIG. 4, block 52), the peripheral 16 sends the data to the target mobile unit 14 (FIG. 4, block 52). Otherwise, the peripheral 16 continues to update its local data (FIG. 4, block 50) until a trigger frame from the target mobile unit 14 is received (FIG. 4, block 52).

The peripheral 16 may determine that a trigger frame has been received in a variety of different ways. In some embodiments, the peripheral 16 compares a destination address (e.g., an IEEE 802.11 destination) in the received frame with a value of a locally stored network address or ID assigned to the peripheral 16. In some of these embodiments, the peripheral 16 additionally may confirm that the received frame is a trigger frame based on a comparison of a value indicating the type of the received frame (e.g., an IEEE 802.11 control frame, such as a CTS frame, or an IEEE 802.11 data frame) with a locally stored frame type value. In embodiments in which the trigger frame contains a destination address and a source address (e.g., a source address in an IEEE 802.11 data frame), the peripheral 16 may perform a dual address verification process for determining that the received frame is a trigger frame. In this process, the peripheral 16 verifies that the destination address corresponds to a locally stored address or ID assigned to the peripheral 16 and verifies that the source address corresponds to a locally stored address of ID assigned to the mobile unit 14.

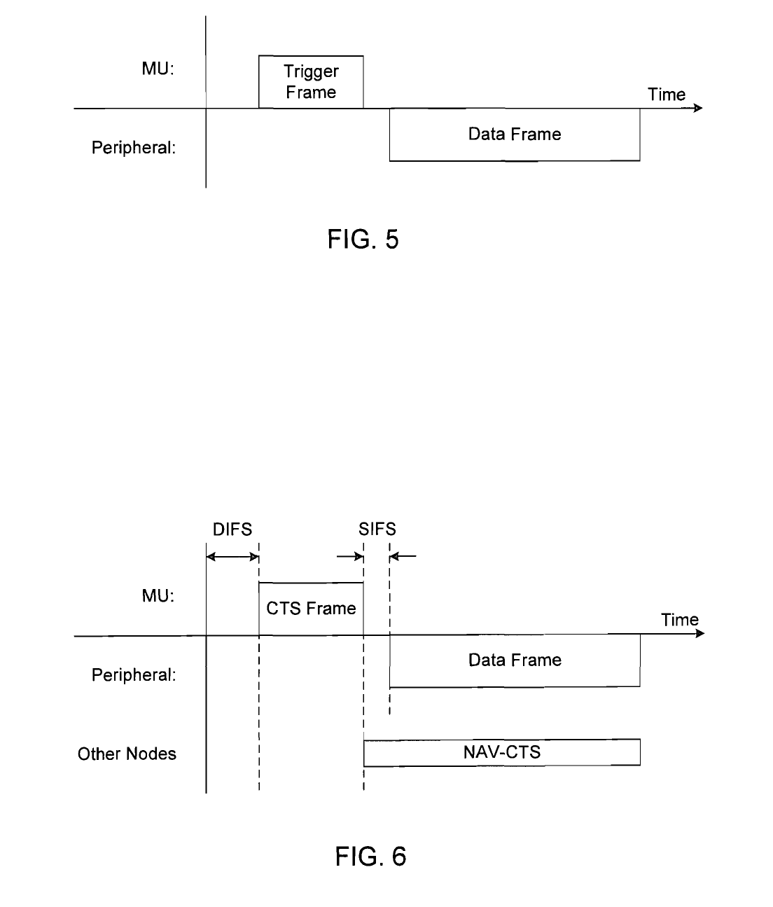

FIG. 5 shows a timing diagram of data transmissions between the target mobile unit 14 and the target peripheral 16 in accordance with the methods shown in FIGS. 3 and 4.

FIG. 6 shows a timing diagram of data transmissions between the target mobile unit 14 and the target peripheral 16 in accordance with the methods shown in FIGS. 3 and 4, where the trigger frame is a CTS frame. The initial idle period corresponds to the distributed inter-frame spacing (DIFS) and the idle period following the CTS frame corresponds to the short inter-frame space (SIFS). The NAV-CTS period corresponds to the time during which the other nodes in the network 10 suspend their respective transmissions to allow the peripheral 16 to transmits its locally generated data to the mobile unit 14 without interference. In the illustrated embodiment, the mobile unit 14 transmits the CTS trigger frame without any prior transmission of any IEEE 802.11 request-to-send (RTS) frame. In addition, the mobile unit 14 omits the transmission of any IEEE 802.11 acknowledgement (ACK) frames to the peripheral in response to receipt of the local data.

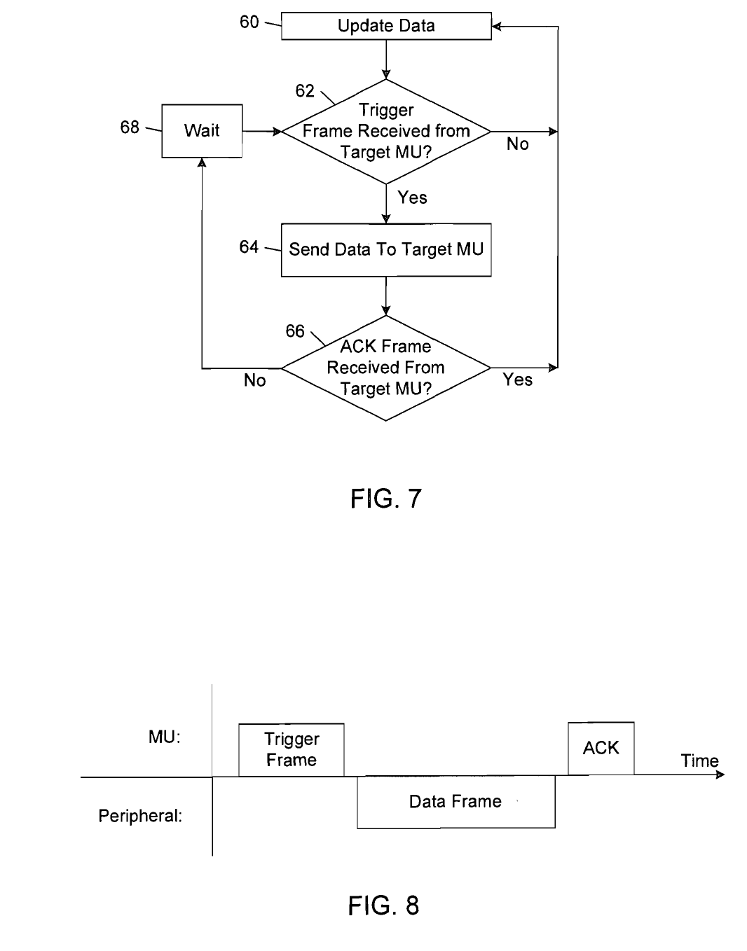

FIG. 7 shows an embodiment of a method of transmitting data from the peripheral 16 to the target mobile unit 14. In accordance with this embodiment, the peripheral 16 updates its local data (FIG. 7, block 60). If a trigger frame is received from the target mobile unit 14 (FIG. 7, block 62), the peripheral 16 sends the data to the target mobile unit 14 (FIG. 7, block 62). Otherwise, the peripheral 16 continues to update its local data (FIG. 7, block 60) until a trigger frame from the target mobile unit 14 is received (FIG. 7, block 62). The peripheral 16 repeats the process if it receives an ACK frame from the target mobile unit 14 (FIG. 7, block 66). Otherwise, the peripheral 16 waits (FIG. 7, block 68) and then determines whether another trigger frame has been received from the target mobile unit 14 (FIG. 7, block 62). If another trigger frame has not been received, the peripheral 16 updates its local data (FIG. 7, block 60) and repeats the process.

FIG. 8 shows a timing diagram of data transmissions between the mobile unit 14 and the peripheral 16 in accordance with the method shown in FIG. 7.

D. Optimizing Peripheral Power Consumption During the Data Exchange Phase of the Communications Protocol

If the peripheral serves a purpose such that data transmissions occur at very regular intervals then it becomes possible for the MU 14 and peripheral 16 to synchronize on that interval, allowing the peripheral's radio to be turned off for a period of time between each data exchange interval. This feature allows for significant power savings especially when the air time required at each interval is small relative to the period of the interval.

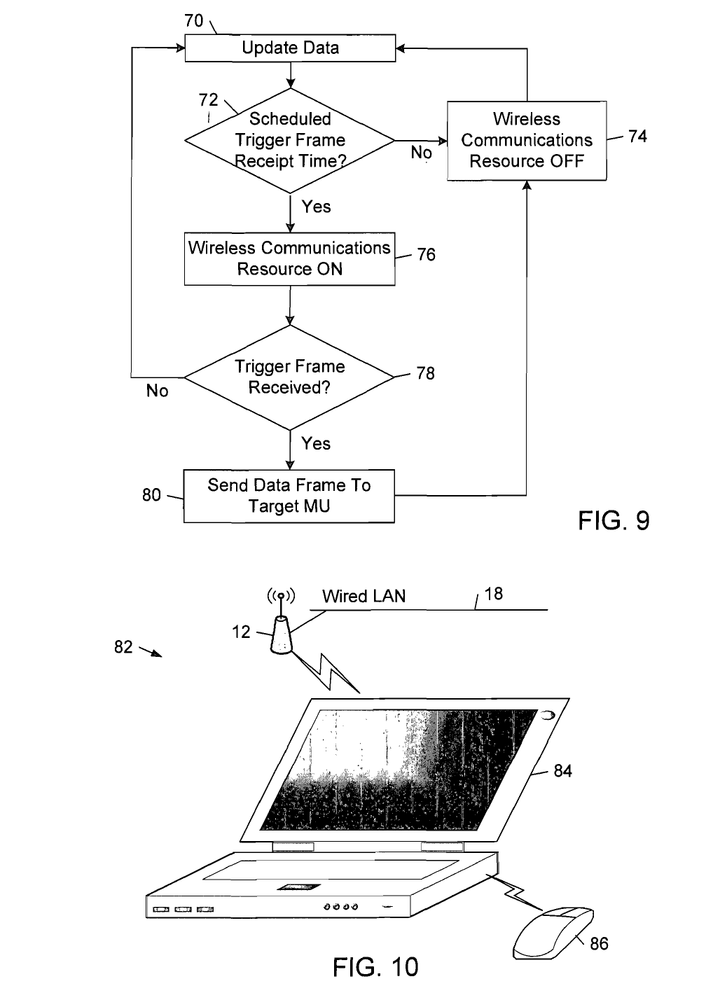

FIG. 9 is a flow diagram of an embodiment of a method of operating the peripheral 16 in a way that leverages trigger frame synchronization to enable the peripheral 16 to reduce power consumption during periods when data is not being exchanged with the target mobile unit 14.

In accordance with this embodiment, the peripheral 16 updates its local data (FIG. 9, block 70). At times outside of the period when the trigger frame is scheduled to be sent by the mobile unit 14 (FIG. 9, block 72), the peripheral 16 turns off (or leaves off) its wireless communications resource 26 (FIG. 9, block 74). During the period when the trigger frame is scheduled to be sent by the mobile unit 14 (FIG. 9, block 72), the peripheral 16 turns on (or leaves on) its wireless communications resource 26 (FIG. 9, block 76). During this period, the peripheral detects the receipt of a trigger frame from the target mobile unit 14. If a trigger frame has been received (FIG. 9, block 78), the peripheral 16 sends the data frame to the target mobile unit 14 (FIG. 9, block 80) and turns off (or leaves off) its wireless communications resource 26 (FIG. 9, block 74). If a trigger frame has not been received (FIG. 9, block 78), the peripheral repeats the process (FIG. 9, blocks 70-80).

In some embodiments, as a method of mitigating failure, the peripheral 16 leaves its radio on after missing some number of consecutive scheduled trigger frames in an effort to re-establish synchronization.

E. Optimizing Multiplexing of the Mobile Unit Wireless Communications Resource During the Data Exchange Phase of the Communications Protocol

The other advantage offered by this solution is that it allows the MU 14 to schedule exactly when it will receive data from the peripheral 16. This is important because the MU's 802.11 radio must be shared between communication with the peripheral and that of a traditional 802.11 wireless network. It may even be the case that these communications occur on different radio channels requiring the MU to switch radio channels before and after communicating with a peripheral. Although not as time efficient as using the same channel, this aspect advantageously allows other network communication to continue on one channel while the MU and peripheral communicate on another channel.

### IV. AN EXEMPLARY COMPUTER MOUSE APPLICATION ENVIRONMENT

A. General Architecture

FIG. 10 shows an embodiment of a local area network 82 in which the mobile unit 14 is implemented by a wireless-enabled computer 84 (e.g., a laptop computer) and the peripheral 16 is implemented by a wireless computer mouse 86. The computer 84 and the wireless computer mouse 86 communicate with each other in accordance with the methods described above and shown in FIGS. 3-6. These communication methods correspond to a modification of the IEEE 802.11 protocol because they do not involve the use of RTS frames or ACK frames. For this reason, the communications between the computer 84 and the wireless computer mouse 86 have low overhead and therefore are highly efficient. These modifications of the IEEE 802.11 standard are tailored to application environments of the type shown in FIG. 10, in which the occurrence of dropped frame is not critical.

B. Bandwidth Consumption of the Exemplary Computer Mouse Application Environment

It is possible to calculate the amount of airspace consumed by peripheral-MU communication if certain assumptions are made as follows:
1. The data transmissions occur at a fixed interval.
2. The data transmissions are of a fixed size.
3. The rate of the transmissions is known.
4. Non-data transmissions between peripheral and MU occur only rarely and can therefore be ignored in any calculation.

As an example, assume that a peripheral mouse is paired with an MU laptop and further that all transmissions occur using a data rate of 2 Mbps (Megabits per second). Furthermore, estimate the size of the mouse State data at 16 bytes per transmission and the poll frame used by the laptop is an 802.11 CTS frame. Lastly, assume that the mouse update rate is 50 Hz implying that the interval between data transmissions will be 1000 msec/50=20 msec (milliseconds). Therefore, to ensure good behavior and a good user experience the State of the mouse must be communicated to the laptop once every 20 msec. The time for one frame exchange would then be:
1. CTS TX @ 2 Mbps=152 μsec (microseconds)
2. Required idle time following CTS (802.11 DSSS SIFS)=10 μsec.
3. Time to transmit mouse State (16 byte payload) @ 2 Mbps=272 μsec.
4. Required idle time following data frame (802.11 DSSS DIFS)=50 μsec.

The total exchange time is then 152+10+272+50=484 μsec. If this exchange occurs once every 20 msec then the air time consumed by this connection is 484/20000=0.0242=2.42% of the total channel bandwidth.

### V. CONCLUSION

The embodiments that are described herein provide system and methods for wireless communications between a peripheral and a target mobile unit in a wireless network environment. In accordance with these embodiments, the mobile unit initiates all data exchanges between the mobile unit and the peripheral using a trigger frame. The peripheral delays any data transmissions to the mobile unit until the peripheral receives the trigger frame from the target mobile unit. In some embodiments, this feature is leveraged to: enable the mobile unit to clear a wireless channel for communications between the mobile unit and the peripheral; enable the mobile unit to optimize the multiplexing of a wireless communications resource between peripheral communications and other network communications; and enable the peripheral to reduce power consumption during periods when data is not being exchanged with the target mobile unit.

1. A method, comprising:
in response to a determination to acquire data wirelessly from a target peripheral, wirelessly transmitting a trigger frame in accordance with a wireless local area network (LAN) communications protocol, wherein the trigger frame reserves a wireless channel for a duration sufficient to meet a time needed by the target peripheral to transmit local data, and the trigger frame prompts the target peripheral to transmit the local data over the wireless channel during the reserved duration in accordance with a wireless local area network (LAN) communications protocol;
receiving local data transmitted by the target peripheral over the wireless channel; and
processing the received local data.

2. The method of claim 1, wherein the trigger frame comprises a duration value equal to the reserved duration.

3. The method of claim 1, wherein the transmitting comprises wirelessly transmitting the trigger frame in accordance with an IEEE 802.11 wireless communications protocol.

4. The method of claim 3, wherein the trigger frame is an IEEE 802.11 clear-to-send (CTS) frame.

5. The method of claim 4, wherein the transmitting is performed without any prior transmission of any IEEE 802.11 request-to-send (RTS) frames.

6. The method of claim 3, wherein the trigger frame is an IEEE 802.11 data frame.

7. The method of claim 3, further comprising omitting transmission of any IEEE 802.11 acknowledgement (ACK) frames to the target peripheral in response to receipt of the local data.

8. The method of claim 3, further comprising repeating the transmitting at regular intervals of time without regard to receipt of any IEEE 802.11 data frames containing the local data from the target peripheral.

9. The method of claim 1, further comprising communicating with at least one network device other than the target peripheral in accordance with an IEEE 802.11 wireless LAN transmission protocol, wherein the transmitting, the receiving, and the communicating are performed by a single RF radio transceiver.

10. A method, comprising:
awaiting receipt of a trigger frame from a target mobile unit before wirelessly transmitting local data, wherein the trigger frame reserves a wireless channel for a duration sufficient to meet a time needed to transmit the local data to the target mobile unit in accordance with a wireless local area network (LAN) communications protocol; and
in response to receipt of the trigger frame, transmitting the local data to the target mobile unit over the wireless channel during the reserved duration in accordance with a wireless local area network (LAN) communications protocol.

11. The method of claim 10, further comprising updating the local data during the awaiting.

12. The method of claim 10, wherein the transmitting comprises wirelessly transmitting the local data to the target mobile unit over the wireless channel during the reserved duration in accordance with an IEEE 802.11 wireless communications protocol.

13. The method of claim 12, further comprising repeating the updating, the awaiting, and the transmitting, wherein the repeating comprises:
after the transmitting determining whether an IEEE 802.11 acknowledgement (ACK) frame was transmitted by the target mobile unit in response to the transmitting;
repeating the updating in response to a positive determination that the ACK frame was transmitted by the target mobile unit; and
repeating the awaiting and transmitting in response to a negative determination that the ACK frame was transmitted by the target mobile unit.

14. The method of claim 12, wherein the trigger frame comprises an IEEE 802.11 destination address value identifying the target peripheral and, before the transmitting, further comprising determining that the trigger frame has been received based on a comparison of the destination address value to a locally stored address value.

15. The method of claim 12, wherein the trigger frame is an IEEE 802.11 clear-to-send (CTS) frame.

16. The method of claim 12, wherein the trigger frame is an IEEE 802.11 data frame.

17. The method of claim 10, wherein the transmitting is performed by a wireless communications resource, and
further comprising, during the awaiting, turning off the wireless communications resource at times outside transmission periods during which respective trigger frames are scheduled to be sent by the target mobile unit.

18. The method of claim 17, further comprising turning on the wireless communications resource at times outside the transmission periods in response to failure to receive any trigger frames from the mobile unit in a specified number of consecutive ones of the transmission periods.

19. A system, comprising:
a mobile unit comprising a processing system and an RF radio transceiver,
wherein, in response to a determination to acquire data wirelessly from a target peripheral, the mobile unit wirelessly transmits a trigger frame via the RF radio transceiver in accordance with a wireless local area network (LAN) communications protocol, the trigger frame reserves a wireless channel for a duration sufficient to meet a time needed by the target peripheral to transmit local data to the mobile unit over the wireless channel during the reserved duration in accordance with a wireless LAN communications protocol.

20. The system of claim 19, wherein the mobile unit wirelessly transmits the trigger frame in accordance with an IEEE 802.11 wireless communications protocol.

21. The system of claim 20, wherein the trigger frame is an IEEE 802.11 clear-to-send (CTS) frame.

22. The system of claim 20, wherein the mobile unit transmits the trigger frame without any prior transmission of any IEEE 802.11 request-to-send (RTS) frames.

23. The system of claim 20, wherein the trigger frame is an IEEE 802.11 data frame.

24. The system of claim 20, wherein the mobile unit omits transmission of any IEEE 802.11 acknowledgement (ACK) frames to the target peripheral in response to receipt of any IEEE 802.11 data frames containing the local data from the target peripheral.

25. The system of claim 20, wherein the mobile unit repeats the transmission of the trigger frame at regular intervals of time without regard to receipt of the local data from the target peripheral.

26. The system of claim 20, wherein the mobile unit communicates with an access point via the RF radio transceiver in accordance with an IEEE 802.11 wireless transmission protocol.

27-36. (canceled)

37. A system, comprising:
a peripheral comprising a processing system and an RF radio transceiver, wherein
the peripheral awaits receipt of a trigger frame from a target mobile unit before wirelessly transmitting local data, wherein the trigger frame reserves a wireless channel for a duration sufficient to meet a time needed to transmit the local data to the target mobile unit in accordance with a wireless local area network (LAN) communications protocol, and
in response to receipt of the trigger frame, the peripheral transmits the local data to the target mobile unit over the wireless channel during the reserved duration in accordance with a wireless LAN communications protocol.

38. The system of claim 37, wherein the peripheral wirelessly transmits the local data to the target mobile unit over the wireless channel during the reserved duration in accordance with an IEEE 802.11 wireless communications protocol.
